(19) United States
(12) Patent Application Publication
(10) Pub. No.: US 2024/0109537 A1
(43) Pub. Date: Apr. 4, 2024

(54) Adaptive Driving System

(71) Applicant: Bruce Lee Johnson, Woodinville, WA (US)

(72) Inventor: Bruce Lee Johnson, Woodinville, WA (US)

(21) Appl. No.: 17/937,673

(22) Filed: Oct. 3, 2022

(51) Int. Cl. B60W 30/12; B60W 30/14; B60W 30/18; B60W 40/06; B60W 40/105; B60W 40/13; B60W 60/00; H04W 4/40

(52) U.S. Cl. CPC B60W 30/12; B60W 30/143; B60W 30/18163; B60W 40/06; B60W 40/105; B60W 40/13; B60W 60/001; H04W 4/40; B60W 2040/1307; B60W 2420/54; B60W 2422/10; B60W 2510/22; B60W 2556/45

(57) ABSTRACT

In various examples, the ride quality of an autonomous vehicle is improved by selecting a lateral lane position based at least in part on measured road-condition information. In various examples, information describing the condition of a road is obtained by measuring vehicle motion and road noise using sensors on the vehicle. This information is stored in association with the lateral lane position of the vehicle to produce a profile describing expected ride quality as a function of lateral lane position. In some examples, this information is uploaded and aggregated on a remote server to produce a lateral profile of road condition using information collected by many vehicles.

### BACKGROUND

Road conditions vary widely around the word. Differences in construction, age, traffic load, weathering, and underlying soil conditions all play a role in how road condition changes over time. For example, in cold climates, freezing temperatures in the winter may cause trapped water in the road to expand leading to cracking and potholes. Different maintenance procedures such as chip sealing, the addition of splines, and expansion gaps may contribute to different wear characteristics of the road. A road in poor condition can contribute to poor vehicle handling characteristics, wear or damage to the vehicle fleet, a reduction in safety, and increased road noise. In addition, degraded roads left neglected can degrade rapidly resulting in more expensive repairs in the future. Therefore, monitoring and adapting to the condition the roadway is an important problem when controlling an autonomous vehicle.

### BRIEF DESCRIPTION OF THE DRAWINGS

Various techniques will be described with reference to the drawings, in which:

FIG. 1 illustrates an example of a road with variable conditions and wear over its width and length, in at least one embodiment;

FIG. 2 illustrates an example of a vehicle with a lane position sensor and a position sensor, in at least one embodiment;

FIG. 3 illustrates an example of a vehicle suspension with a sensor used to measure road-condition, in at least one embodiment;

FIG. 4 illustrates an example of a control system of an autonomous vehicle that collects and uses road-condition information to determine a desired position within a lane for travel, in at least one embodiment;

FIG. 5 illustrates an example of a server for storing, processing, and distributing road-condition information, in at least one embodiment;

FIG. 6 illustrates an example of a collection of road-condition samples and a resulting lane condition profile, in at least one embodiment;

FIG. 7 illustrates an example of a data structure storing road-condition information, in at least one embodiment;

FIG. 8 illustrates an example of a process that, as a result of being performed by one or more processors of a computer system, causes the computer system to collect road-condition information, in at least one embodiment;

FIG. 9 illustrates an example of a process that, as a result of being performed by one or more processors of a computer system, causes the computer system to determine a road-condition profile, in at least one embodiment;

FIG. 10 illustrates an example of a process that, as a result of being performed by one or more processors of a computer system, causes the computer system to determine a desired position within a lane of a road based at least in part on road-condition information, in at least one embodiment;

FIG. 11 illustrates an example of a process that, as a result of being performed by an autonomous vehicle and a road-condition server, collects, processes, and distributes road-condition information usable to control the autonomous vehicle, in at least one embodiment; and

FIG. 12 illustrates a system in which various embodiments can be implemented.

### DETAILED DESCRIPTION

The present document describes systems and methods that, in various examples, measure the quality of a road surface by measuring road noise and vibration from a vehicle moving over the road surface. In various examples, the vehicle may be an automobile, truck, tractor trailer, electric car, autonomous vehicle, motorcycle, or in some examples, a trailer towed behind another vehicle. The road can be a highway, secondary road, driveway, or surface made from asphalt, concrete, gravel, dirt, brick, pavers, or other road-making material. In various examples, road noise and vibration is measured with a microphone, transducer, piezo-electric sensor, or sound sensor inside and/or outside the vehicle cabin. Some embodiments include one or more sensors on the suspension system of the vehicle to measure vibration or suspension travel. In many examples, information collected about road quality is stored in association with geographic location data (such as GPS data), and lane position information collected by the vehicle.

In some examples, this information about road quality is uploaded via a computer network and aggregated by a server. In some examples, road-quality information is collected from a plurality of different vehicles. Information can be uploaded from the vehicle via a cellular, WiFi, Bluetooth, or other wireless network as it is collected. In some examples, information is buffered in memory on the vehicle and then uploaded in bulk when the vehicle comes in range of a suitable wireless network. In some examples, many vehicles are able to upload their road-quality information to the server, and the server develops a more comprehensive picture of road quality based on precisely where within a lane of travel each vehicle was traveling. In one example, aggregated road quality information from multiple vehicles allows the server to construct a wear profile across the width of a lane of travel based on differing lane positions of multiple vehicles. As more data is collected from vehicles traveling on a road with different lane positions, the server is able to determine where a lane of a road is heavily worn, and where it is not. In one embodiment, the server identifies wear areas within a lane that are in poor condition, and alternative lateral positions within a lane (perhaps closer to one edge or another of the lane) where the road is smother and provides a better ride. For example, the server is able to process the information and determine that the center of a lane is rough and worn, but that the lane is smother 20 inches to the right of center. The server is also able to evaluate the quality of individual lanes of a multi-lane road. For example, the server can determine that the right lane is in need of repairs due to poor condition, but that the left lane is still serviceable. In some examples, a vehicle uses this information to direct an autonomous vehicle to travel in one lane vs another to improve the safety and ride quality of the vehicle.

In various examples, the road quality information provided to the server includes position information that describes the location on the road, the lane of travel, and the position within the lane of travel. The location on the road, in some examples, is collected using GPS or cellular tower position data and identifies the road and approximate geographic location. The lane of travel can be determined based on the direction of travel, and also by analyzing images obtained from one or more forward-facing cameras located on the vehicle. In various examples, images from a forward facing camera are processed to determine the vehicle's lateral position within a lane. In some vehicles, for example, lateral position within a lane is monitored as part of a lane-keeping system, and the lane-keeping system shares lateral lane position information with a road-condition monitoring system on the vehicle. In some examples, the wheelbase measurement is also provided to the server, so that the position of the tires on the road can be determined and correlated to the measured road noise of the vehicle.

Various embodiments may be used as part of an autonomous vehicle control system. Many autonomous or semi-autonomous vehicles include lane centering or lane-keeping systems that either attempt to keep the vehicle in the center of a lane, or assist in keeping the vehicle within the boundaries of a designated lane. In at least one embodiment, aggregated road-condition information collected on a server or road-condition information collected on the vehicle itself is used to calculate a desired position within a lane of travel. In some examples, road-condition information for the lane is downloaded from the server, and a position within the lane is calculated based on the downloaded information. In some examples, a position within a lane is selected to produce less road noise and/or a smoother ride. In some examples, the autonomous vehicle may measure the condition of various positions within the lane by moving back and forth across the lane while recording road noise and suspension travel, and then use this information to select a lateral lane position that produces a smoother ride and/or less road noise. For example, this selection may include a selection of a lane from multiple available lanes, and a lateral offset within the chosen lane.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure, certain embodiments may be capable of achieving certain advantages, including some or all of the following: (1) providing quieter and/or smoother ride of a vehicle by choosing a lane and lateral lane position that will result in an improved ride, (2) reducing wear and tear on an autonomous vehicle by avoiding lane positions that have large defects such as potholes or worn expansion joints, (3) aggregating road-condition information from a plurality of vehicles to provide a profile of road condition, and (4) aggregating a comprehensive database of road condition useful for managing road maintenance and repair.

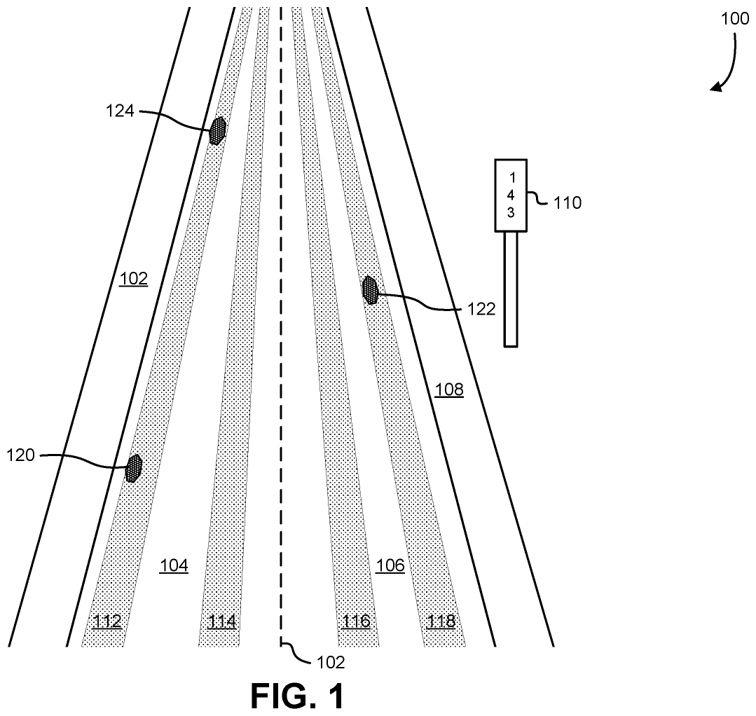

FIG. 1 illustrates an example of a road with various conditions and wear over its width and length, in at least one embodiment. In many examples, a section of a road tends to wear generally evenly in length, but variably in lateral width because of the predominant direction of travel and predominant patterns of use by vehicles. In at least one example, a road 100 has a left shoulder 102, a left lane 104, a right lane 106, and a right shoulder 108. In some examples, the right lane 106 and the left lane 104 support traffic in the same general direction (such as in a divided highway). In other examples, the right lane 106 and the left lane 104 support traffic in generally opposite directions.

Each lane of the road 100 may exhibit various wear patterns and/or defects such as exposed aggregate leading to roughness, loose gravel or chip seal, expansion joints, grooves, rumble strips, potholes, and so on. In the illustrated example, road 100 includes a first pothole 120, a second pothole 122, and a third pothole 124. The right lane 106 includes two strips of wear 116 and 118 where the wheels of most vehicle traffic ride. The left lane 104 includes two strips of wear 112 and 114 where the wheels of most vehicle traffic ride. As a result, the ride quality and road noise for a vehicle often change when driving based at least in part on the lateral position of the vehicle within the lane. For example, when both tires are within the wear areas, the ride may be rougher or smoother than when one or both pairs of tires are outside the wear strips. In addition, the right lane 106 may have different wear than the left lane 104 making one or the other lanes more desirable to drive on. The road 100 may include road signs such a mile marker 110 to indicate a position along the road. In at least one example, an autonomous vehicle includes one or more cameras to recognize road signs, and this information is used to identify a road segment.

In the present document, a road may be a street, path, highway, or other surface on which vehicles travel. A road may include one or more lanes, which may be for vehicles traveling in the same general direction or generally opposing directions. A lane position or lateral lane position is a position within a lane, generally laterally at a right angle to the direction of travel. For example, a lateral lane position may specify how far from lane center a vehicle is when traveling down the highway.

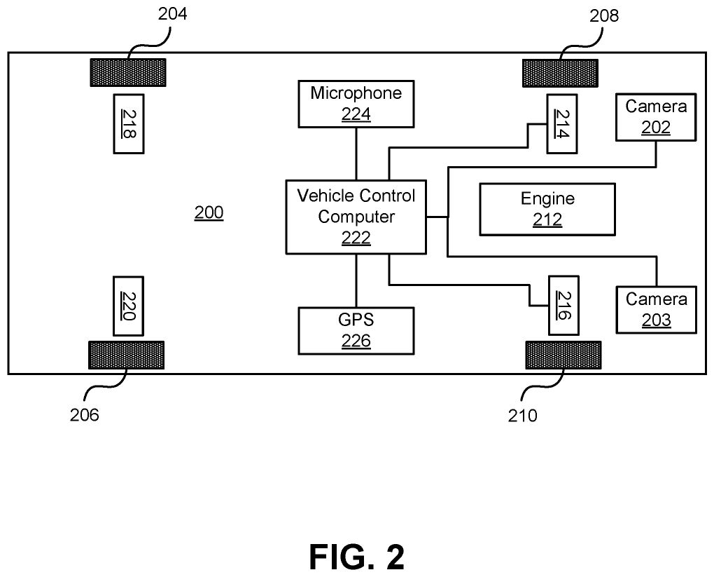

FIG. 2 illustrates an example of an autonomous vehicle with a lane position sensor and a global positioning sensor, in at least one embodiment. In the illustrated example, the vehicle 200 can be an automobile, truck, light truck, tractor trailer, semi, or on-road vehicle. Some examples, the vehicle 200 is an autonomous or semi-autonomous vehicle having one or more sensors that detect the lateral position of the vehicle 200 within a lane and/or across the width of a road. In the illustrated example, vehicle 200 includes a first camera 202 and a second camera 203 that provide binocular images to a vehicle control computer 222. The vehicle control computer 222 includes a processor and memory storing executable instructions that, as a result of being executed by the processor, cause vehicle control computer 222 to process one or more images provided by the first camera 202 and the second camera 203 and determine the lateral position of the vehicle 200 within the current lane on the roadway. Some examples use other methods to determine lateral position such as using a single camera combined with a depth-imaging system such as radar, lidar, ultrasonic, or an RGBD (red-green-blue plus depth) imaging system. In some examples, lateral position detection includes identifying the current lane from one or more lanes on a roadway, and identifying the lateral position within the current lane for the vehicle 200.

In the illustrated example, vehicle 200 has two rear wheels 204 and 206, two front wheels 208 and 210, and an engine 212. In various examples, the engine is an electric motor, a fuel cell motor, hydrogen engine, an internal combustion engine, a diesel engine, or a hybrid engine. Some examples may include multiple engines. For example, some embodiments use separate engines to drive each wheel. In various examples, a wheel can include various suspension components that allow the wheel to move up and down relative to the vehicle chassis in response to unevenness in the road surface or shifting forces on the vehicle 200. In the illustrated example, each wheel has corresponding independent suspension components where wheel 204 has suspension components 218, wheel 208 has suspension components 214, wheel 206 has suspension components 220, and wheel 210 has suspension components 216. The suspension components can take various forms such as coil springs and shocks, struts, leaf springs, rubberized torsion suspensions, and air-ride systems. In some embodiments, suspension components associated with a wheel include one or more position sensors that record suspension deflection. Appropriate position sensors may include linear or rotary potentiometers, optical sensors, or magnetic Hall effect sensors. Some examples use strain gauges on stressed suspension components to estimate spring deflection as a proxy for suspension movement. Another example uses an accelerometer attached to a moving suspension component to infer suspension movement by integrating acceleration over time. One example uses a piezo-electric sensor attached to the suspension to measure vibration of the suspension over time. At least one embodiment uses one or more of the above sensors to determine acceleration of the vehicle chassis, which corresponds to the forces on the payload (such as passengers) of the vehicle.

In at least one embodiment, vehicle 200 includes a microphone 224 connected to the vehicle control computer 222. The microphone 224 can be connected to the vehicle control computer 222 using an analog to digital converter so that digitized sound information is available to the vehicle control computer 222. In one example, microphone 224 is located in the vehicle cabin and records road noise. In various examples, microphone 224 can be located in the engine compartment, trunk, or cargo area where road noise can still be recorded while being isolated from noise within the cabin. In one embodiment, road noises isolated from the cabin noise by monitoring output from the vehicle sound system and subtracting it from the sound recorded by the microphone 224. In some examples, this is accomplished by placing one microphone near a vehicle speaker, and another microphone away from the vehicle speaker. The digitized sound information is processed by the vehicle control computer 222 to produce a measure of road noise.

At least one embodiment of vehicle 200 includes a global positioning system sensor 226. The global positioning system sensor 226 provides global position information to the vehicle control computer 222. The global position information is used by the vehicle control computer 222 to identify the road on which vehicle 200 is traveling and determine an approximate longitudinal position on that road. In some examples, GPS information provided by the global positioning system sensor 226 is used to identify a specific highway on which vehicle 200 is traveling, an approximate mile marker, and in some examples, a direction and speed of travel. In many examples, information identifying a specific lane and lateral position within that lane are determined by other mechanisms such as those described above.

In various examples, the vehicle control computer 222 uses information from the cameras 202 and 203 and the GPS sensor 226 to identify the road on which the vehicle is traveling and a lateral position within the lane of travel. For example, GPS information can be used in coordination with a navigation database to identify a road on which the vehicle is traveling, and binocular images obtained from the cameras can be used to determine the location of the road and lanes relative to the vehicle's position. The techniques described herein can be adapted to other vehicle systems involving a lane of travel such as warehouse robots which may use other systems for identifying a vehicle position and lateral position within lane of travel. For example, some warehouse robots use a wire embedded in a floor surface, and lateral position is determined by detectors in the robot detecting a current in the wire. Such vehicle systems that include automatic navigation and semiautonomous or autonomous operation can therefore make use of the techniques herein.

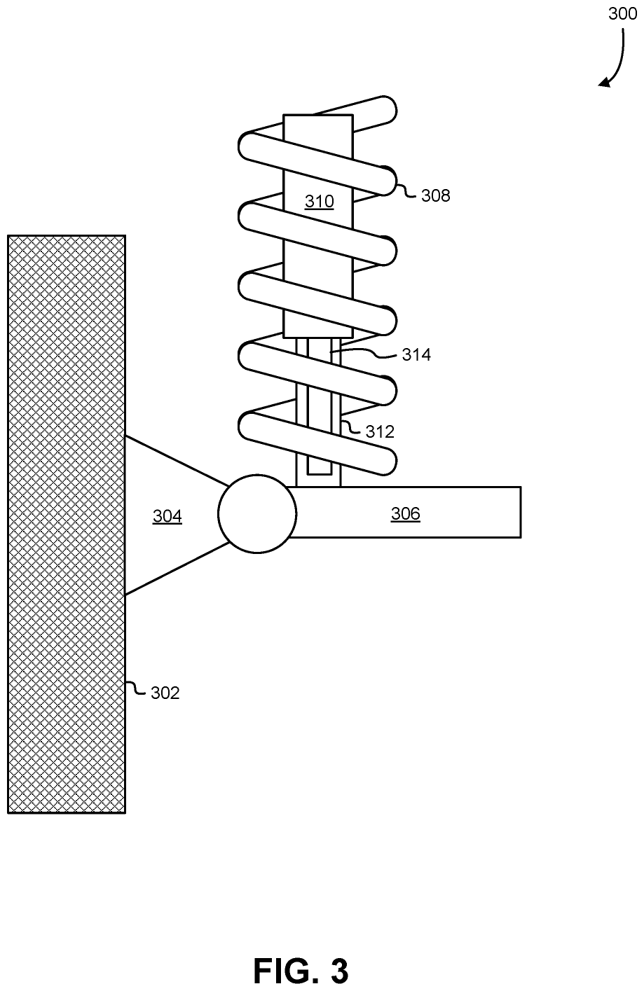

FIG. 3 illustrates an example of a vehicle suspension with a sensor used to collect road-condition information, in at least one embodiment. In addition to or in place of a sound sensor, some examples use one or more sensors placed on the vehicle suspension to measure suspension travel, movement, or vibration. FIG. 3 illustrates an example automotive suspension with a wheel 302 connected to a constant velocity (“CV”) joint assembly 306 and a protective boot. In various examples, the wheel is connected to one or more springs 308. Springs can take the form of coil springs, leaf springs, airbags, or rubber suspension components. In addition, various examples may include shock absorbers or dampening components to improve the ride and performance of the suspension. Sensors that measure suspension deflection can be coupled to either springs or dampening components to provide a measure of suspension motion. In the example illustrated in FIG. 3, a spring assembly includes a shock body 310 and shock piston 312 which moves relative to the shock body 310. In at least one embodiment, a position sensor 314 is positioned on the shock piston 312 and measures movement of the shock piston 312 relative to the shock body 310. A signal from the position sensor 314 is provided to a vehicle control computer, which processes the signal to estimate road condition as described herein. In one example, the signal represents an absolute position, and the vehicle control computer differentiates the signal to obtain a measure of suspension velocity over time. In some examples, the velocity measure is differentiated to estimate acceleration which provides a measure of the forces on the vehicle payload. In some examples, suspension velocity is used as an estimate of road smoothness.

Other types of suspension sensors may be used in addition to the example illustrated in FIG. 3. In one embodiment, a strain gauge placed on a flexible suspension component such as a spring. The strain gauge measures the force on the flexible suspension component, and therefore is a proxy for suspension movement as the force on a spring is generally proportional to the deflection of the spring. In another example, a piezo-electric sensor is placed on a suspension component, which provides an electrical signal in response to vibration. Use of a piezoelectric sensor has the advantage of providing direct measurement of suspension vibration rather than position, which is desirable in some applications.

In some examples, a sensor such as an accelerometer can be placed on an unsprung component of the vehicle so that motion of the unsprung component can be measured. In other embodiments, the sensor is attached to a sprung component such as the passenger cabin, thereby measuring the sprung ride quality after smoothing by the suspension.

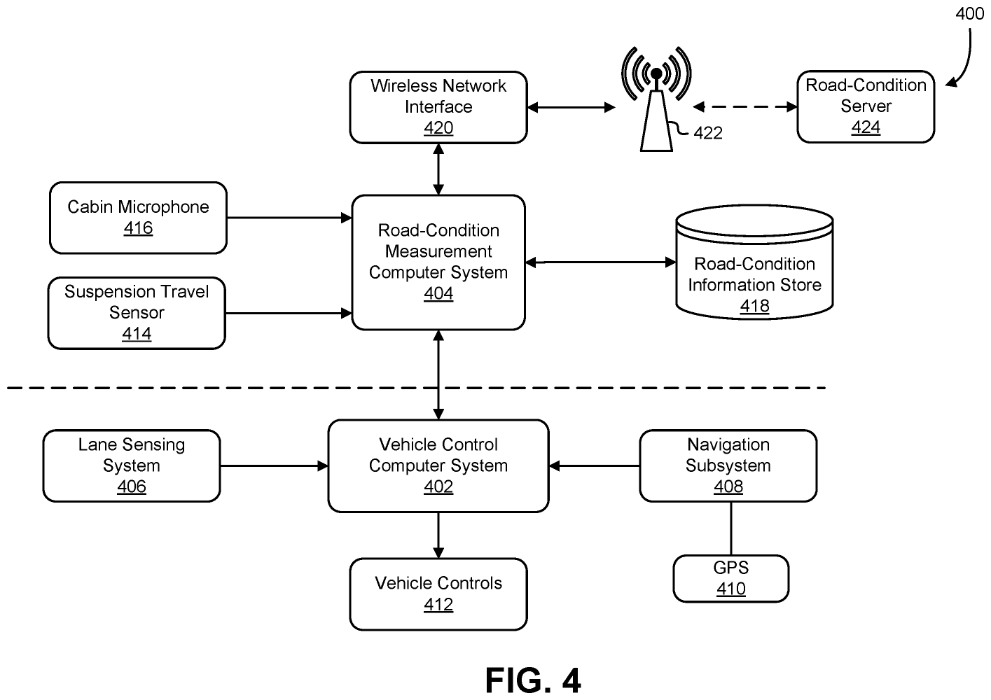

FIG. 4 illustrates an example of a control system of an autonomous vehicle that collects and uses road-condition information to determine a desired position within a lane for travel, in at least one embodiment. The example control system 400 illustrated in FIG. 4 is partitioned into two functional portions divided by a horizontal dashed line. The lower portion shows components generally used for autonomous (or semi autonomous) vehicle control and navigation, and the upper portion shows components generally used for determining road condition, in various embodiments, these portions may be integrated into a single computer system with one or more processors and computer readable memory containing instructions that, as a result of being executed by the one or more processors, cause the system to implement the features described below.

In at least one example, the vehicle control computer system 402 includes one or more processors and one or more computer readable memories with instructions that cause the vehicle computer system 402 to interface with a lane sensing system 406, a navigation subsystem 408, and a set of vehicle controls 412. In at least one embodiment, the lane sensing system 406 includes one or more cameras that capture images of the roadway. In at least one example, the lane sensing system 406 analyzes the images and determines a lateral position of the vehicle based on the location of the one or more cameras on the car and the location of roadway features such as the centerline and road edges. Some examples use radar, laser infrared direction and ranging (“lidar”), or other 3D imaging technology to identify the roadway and lateral position of the vehicle on the roadway. In some examples, this information is obtained from a lane-keeping or lane-centering system on the vehicle.

In one embodiment, the navigation subsystem 408 determines vehicle position using a global positioning system (“GPS”) 410. The GPS 410 provides a global location to the navigation subsystem 408. The navigation subsystem 408 includes a database of street and road information that allows the navigation subsystem 408 to correlate the obtained global position with a specific location on a specific road or street. In some examples, GPS information is sufficient to identify a specific lateral position along the roadway in the direction of travel. In many examples however, GPS information provides only an approximate longitudinal position on the roadway and does not provide sufficient accuracy to provide a precise location laterally across the width of the roadway. In such cases, the vehicle control computer system 402 obtains this information from the lane sensing system 406.

In some examples, GPS information can be used to refine the navigation database by refining an accurate location of a roadway based on information from the lane sensing system 406. In such embodiments, the lateral positioning of the roadway in the navigation database in the navigation subsystem 408 is updated with the actual lane position as guided by the lane sensing system 406. This allows the vehicle to operate precisely and safely on such roads in the future even in the event that the lane sensing system 406 fails and the vehicle is forced to rely only on GPS signals alone for lane keeping or centering functions.

In at least one embodiment, the vehicle control computer system 402 determines the current lateral position on the current roadway using the information provided by the navigation subsystem 408 and the lane sensing system 406, using this information, the vehicle control computer system 402 sends commands to a set of vehicle controls 412 that control steering, throttle, and brakes of the vehicle to cause the vehicle to move down the roadway while maintaining a desired lateral position within the current lane. Some embodiments use a desired lateral position set at the center of the current lane. However, improved examples use information from a road condition measurement computer system 404 to determine a desired lateral lane position based at least in part on road condition. For example, using road-condition information, the vehicle control computer system 402 may determine that a lateral lane position closer to the edge of the roadway may provide a smoother ride with less noise and less vibration than a desired lane position in the lateral center of the lane. With many highways this is often the case, as increased wear, potholes, broken expansion joints, exposed aggregate, and other wear issues often cause a rough ride where vehicles often travel.

In at least one example, the control system 400 includes a road-condition measurement computer system that measures and distributes road-condition information to the vehicle control computer system 402. Road-condition information can be determined using a variety of methods. In one example, the road-condition measurement computer system 404 acquires sound information from a cabin microphone 416, extracts road noise from the sound information, and uses this information to approximate road condition. In another example, the road-condition measurement computer system 404 by monitoring one or more suspension travel sensors 414 such as those described above. In yet another example, the road-condition measurement computer system 404 uses a combination of these techniques to determine road condition at the current lane lateral position.

In some examples, the road-condition measurement computer system 404 acquires road-condition information via a wireless network interface 420 from a remote road-condition server 424. In at least one embodiment, the wireless network interface 420 connects to the road-condition server 424 using a wireless network 422 such as a cellular network, satellite network, Wi-Fi network, or wireless network. In at least one example, the road-condition server 424 is a computer system on a computer network which may be connected directly or indirectly to the wireless network 422. The road-condition server 424 maintains a database of road-condition information which may be collected from one or more autonomous vehicles. In various examples, this information is aggregated by the road-condition server 424 into a profile of lateral wear where, for a given road segment and lane position, an estimate of road condition can be retrieved. In some examples, the profile of lateral wear is downloaded from the road-condition server 424 to the road-condition measurement computer system 404 which then uses this to evaluate the profile to identify a desired lateral position within a lane. In various examples, the desired lateral position may be dependent on additional factors such as the type of vehicle being driven, the vehicle's wheel track width, overall width, weight, and presence of other lanes or obstructions near the lane of travel.

In some examples, the road-condition information store 418 may be a computer-readable memory such as a disk drive, flash memory, or solid-state storage device that stores information related to road condition such as road-condition profiles downloaded from the road-condition server 424, and road-condition information collected by the road-condition measurement computer system 404 on the vehicle. In some examples, the road-condition measurement computer system 404 periodically uploads collected road-condition information from the road-condition information store 418 to the road-condition server 424, where, in some examples, the information is aggregated into a set of lateral wear profiles and can be distributed to other vehicles upon request.

Some examples omit the road-condition server 424 and aggregate the road-condition information in the road-condition measurement computer system 404. In such examples, lateral wear profiles can be stored in the road-condition information store 418. Other examples may omit the creation of a lateral profile entirely by moving left and right across the lane to find a lateral position associated with a local minimum of road noise and suspension travel within the lane of travel.

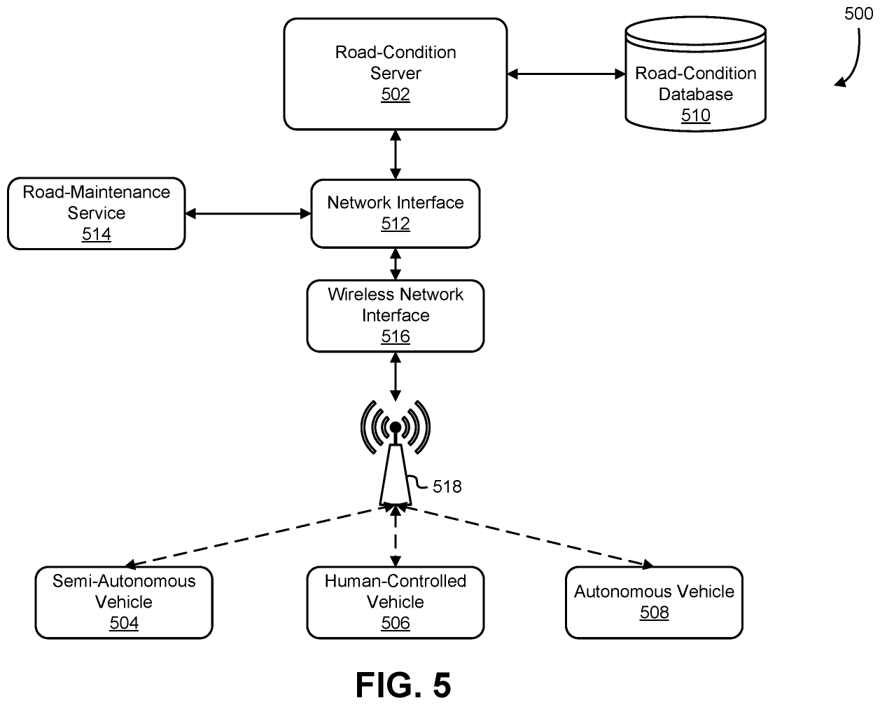

FIG. 5 illustrates an example of a server 500 that stores, processes, and distributes road-condition information, in at least one embodiment. A road-condition server 502 is a computer server system that includes one or more processors and computer readable memory storing executable instructions that, when executed, cause the road-condition server 502 to obtain information from one or more vehicles over a wireless network, process the received information, and store the information in a road-condition database 510. In various examples, the road-condition server 502 is connected to a network interface 512. The network interface 512 can be an ethernet interface, a Wi-Fi interface, a cellular interface, a fiber-optic interface, a USB interface, or other network connection. In some examples, the road-condition server 502 is connected to the Internet. In at least one embodiment, the road-condition server 502 is able to access a wireless network 518 via a wireless network interface 516. In some examples, the road-condition server 502 is connected directly to the wireless network interface 516. In other examples, the road-condition server 502 accesses the wireless network interface 516 via one or more intermediate routers or switches, which may include network interface 512.

In at least one embodiment, a road maintenance service 514 accesses the road-condition server 502 via the network interface 512 in order to obtain road-condition information useful for scheduling road repairs and service. For example, some examples provide an application programming interface on the road-condition server 502 for downloading road-condition information from the road-condition database 510 relevant to a requested section of road. In some embodiments, the road-condition server 502 monitors road-condition information in the road-condition database 510, and generates a set of alerts when the road-condition server 502 detects that the condition of a road has degraded to the point where repairs are needed. These alert messages are transmitted to the road maintenance service 514 via the network interface 512, causing crews to be notified to perform the necessary repairs and maintenance.

In various examples, a variety of vehicles interact with the road-condition server 502. In some examples, road-condition information is provided by the road-condition server 502 to individual vehicles. In other examples, road-condition information is uploaded by various vehicles to the road-condition server 502. In at least one example, a vehicle measures and evaluates road condition at a given lateral position on a road, and uploads this information to the road-condition server 502. The road-condition server 502 aggregates this road-condition information with existing information in the road-condition database 510, and provides the aggregated lateral wear information in the form of a profile back to the vehicle. The profile provides a measure of road condition is a function of lateral position, as determined by a composite of many vehicles passing over the same section of road.

Many vehicles, and many types of vehicles, may interact with the road-condition server 502. In at least one embodiment, the road-condition server 502 communicates with a semi-autonomous vehicle 504, a human controlled vehicle 506, and an autonomous vehicle 508. A semiautonomous vehicle is a vehicle that provides driver assist features such as lane assist, lane keeping, automatic braking, and adaptive traffic following. An autonomous vehicle is able to provide self-driving for at least a limited amount of time. Human controlled vehicles are controlled by human operators. Each of these vehicle types is able to provide road-condition information to the road-condition server 502. Autonomous and semiautonomous vehicles are able to make use of lateral wear profiles to identify a desired lateral lane position based on measured road condition. For example, semiautonomous vehicles which provide lane centering can select an improved lateral lane position based on road condition that is not necessarily in the center of the lane, thereby providing a quieter smoother ride to the passengers or cargo.

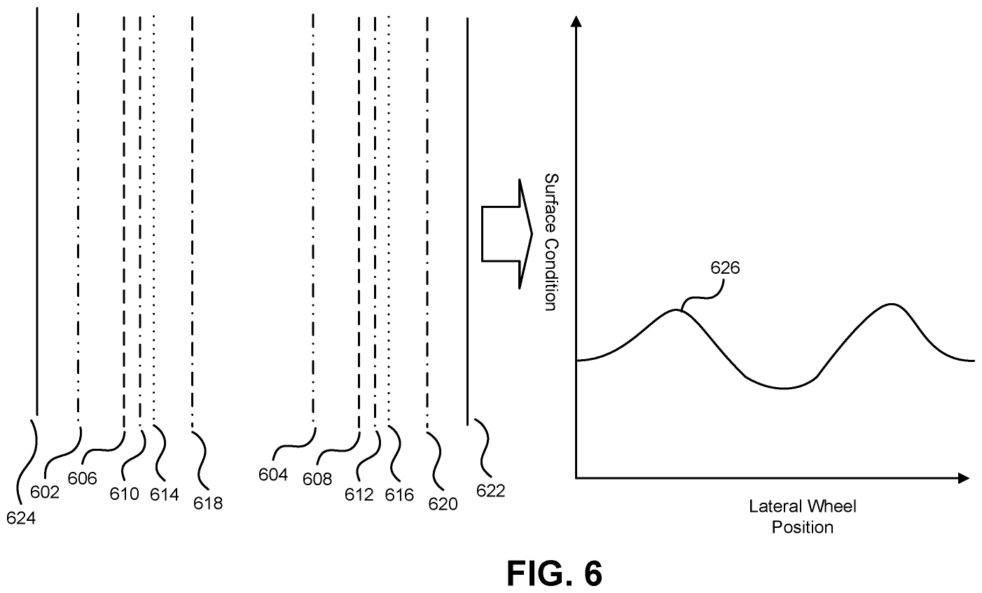

FIG. 6 illustrates an example of a collection of road-condition samples and a resulting lane condition profile, in at least one embodiment. The left side of FIG. 6 illustrates a lane of a road having a right edge 622 and a left edge 624 with the predominant path of traffic from the bottom of the page to the top of the page. A number of ground tracks associated with road-condition samples are illustrated showing the path of vehicle wheels as each vehicle travels longitudinally along the road. For example, a first track 602 and 604 noted by a 2-dot and 1-dash pattern, are associated with road-condition data collected where a vehicle is laterally positioned to the left of lane center. In another example, a second track 620 and 618 represented by a 2-dash and 1-dot pattern are associated with road-condition data collected where the vehicle is laterally positioned to the right of lane center. In at least one embodiment, a plurality of such road-condition data is collected. For example, FIG. 6 illustrates a third track 606, 608, a fourth track 610, 612, and a fifth track 614, 616. In some examples, for each track, a vehicle collects road-condition information which is stored in association with the track. For example, in one Embodiment a vehicle records its lateral lane position and wheel track width, in association with road-condition information collected while traveling over an identified road section. This information can be stored in a memory on the vehicle or uploaded to a network connected server. In some examples, the vehicle collects wear information for each wheel of a track separately. In other implementations, a vehicle measures composite wear information such as cabin noise, and associates this to both wheel tracks. In yet another implementation, a vehicle stores wear information associated with a central lane position, and generates a profile of wear directly associated with lane position of the vehicle.

In various examples, the information shown on the left part of FIG. 6, together with associated road-condition information, is converted into a wear profile 626 that provides a function where ware is determined based at least in part on a wheel's lateral position. In one example, the wear profile 626 shows increases road-condition in two bands across the lateral width of a lane of a road. In some examples where wear is recorded in association with vehicle road position, the wear profile 626 will show road condition as a function of the vehicle's lateral position in the lane. In some examples, the system maintains multiple wear profiles for various vehicle track widths, which improves the accuracy of wear estimations by providing road-condition measures closely matched to both lateral lane position and vehicle track width. For example, with such a system, a large semi tractor trailer would use profiles generated from vehicles with similar wide track widths, and passenger cars would use profiles generated from vehicles with similar narrower track widths.

In embodiments where profiles are maintained for individual lateral tire position, road condition can be estimated for a given vehicle by adding the wear estimate for the lateral position of each tire. For example, for a four-wheeled vehicle traveling at lane position x with a wheel track of y, road condition can be estimated by adding the wear measures suppled by the profile at x+y/2 and x−y/2.

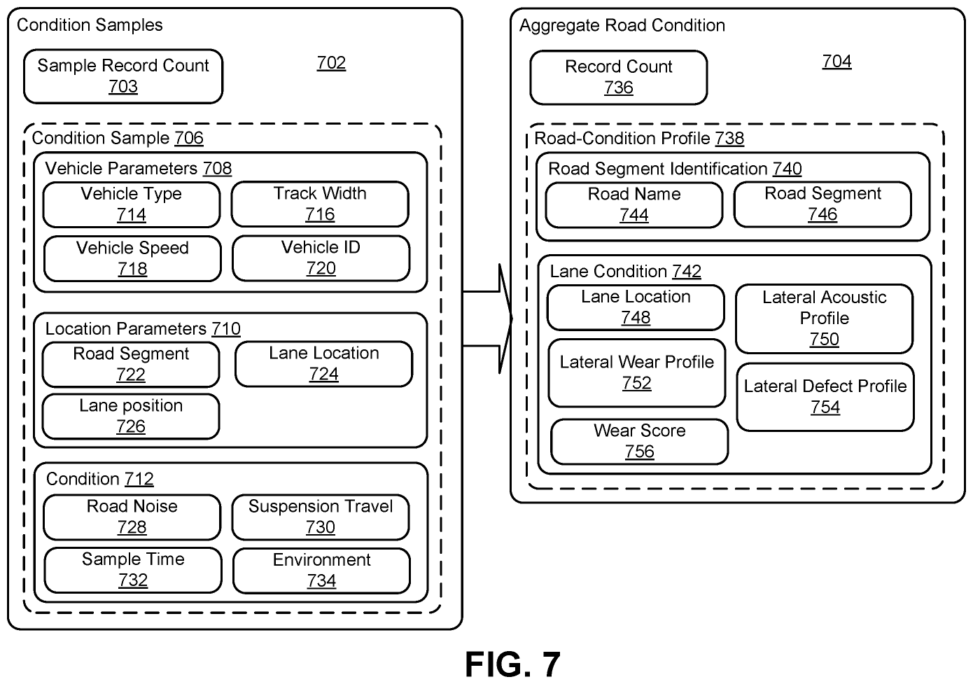

FIG. 7 illustrates an example of a data structure used to store road-condition information, in at least one embodiment. The illustrated data structure includes a condition sample record 702 that is processed by a computer system to produce an aggregate road-condition record 704 which represents a road-condition profile for a particular road segment of a road. In various examples the computer system stores the plurality of condition sample records 702 which can be stored locally on a vehicle or uploaded to a remote computer system which aggregates a plurality of samples to generate one or more aggregate road-condition records 704.

In one example, the condition sample record 702 includes a sample record count 703 that records the number of condition samples. In at least one embodiment, the condition sample record 702 includes one or more condition sample information 706 records. Each condition sample information 706 includes vehicle parameters 708, location parameters 710, and condition information 712. In at least one example, the vehicle parameters 708 describe aspects of the vehicle that collected the condition sample 706 such as vehicle type 714, a track width of the vehicle 716, the vehicle velocity at which the sample was obtained 718, and a vehicle identifier 720. In at least one example, track width is defined as the lateral distance between tires of the vehicle.

In one example, the location parameters 710 include a road segment identification 722, a lane location 724, and a lane position 726. The road segment identification 722 identifies the road, and location on the road when the sample was taken. For example, the road segment identification 722 may identify the highway and mile marker where the sample was taken. The lane location 724 specifies the lane of travel (such as were there are multiple lanes on a divided highway). The lane position 726 specifies the lateral position within the lane of travel.

The condition information 712 includes a road noise measurement 728, a suspension travel measurement 730, and environment information 734. In some examples, suspension travel 730 may include entries for multiple suspension elements such as separate measures for right-hand suspension and left-hand suspension movement. In some examples, road noise measurement 728 a be a cabin noise level, or road noise measure obtained from outside the vehicle. Sample time 732 records a time index when the sample was taken. Environment information 734 is used to store environmental information that can affect the sample such as temperature, precipitation, and whether at the time the sample was taken. Some implementations use this information to generate road-condition profiles specific to particular conditions such as cold-weather driving and wet-weather driving.

In various examples, the condition sample record 702 may be stored on a memory on the vehicle where the sample was collected, and/or uploaded to a server. Aggregation of sample records 702 can be performed by either a computer system on the vehicle or by a remote server to transform them into one or more aggregate road-condition records 704.

In at least one example, the road-condition record 704 includes a record count 736, which records the number of road-condition profiles. A road-condition profile describes the wear of a road segment as a function of lateral position across the road. Each road-condition record 704 includes one or more road-condition profiles 738. In at least one example, each road-condition profile includes a road segment identification 740 and a lane condition 742. The road segment identification 740 describes the road and road segment whose wear is described by the profile. In one example, the road segment identification 740 includes a road name 744 and a road segment 746. The road segment identification describes the road, street, highway or other pathway identifier. In one example the road name 744 is the name of an interstate highway, street, or state highway. In at least one example, the road segment 746 identifies a longitudinal portion of the road, such as a range of mile markers on a highway.

In at least one example, the lane condition includes one or more of a lane location 748, a lateral acoustic profile 750, a lateral where profile 752, a lateral defect profile 754, and a wear score 756. The lane location 748 identifies the lane being profiled for the particular road segment. For example, the lane location 748 may identify a particular lane on a multilane divided highway. The lateral acoustic profile 750, the lateral where profile 752, and the lateral defect profile 754 can be stored as a set of points that can be interpolated to describe a function relating lateral position to an acoustic condition measure, a vibration measure, or a road-condition defect measure respectively. In one example, the lateral acoustic profile 750 describes road noise as a function of lateral position within the identified lane. In another example, the lateral where profile 752 describes suspension movement or vibration as a function of lateral position on the road. In yet another example, the lateral defect profile 754 describes the number of road defects (such as potholes or bad expansion joints) for the road segment as a function of lateral position.

In various examples, a profile is created from a collection of condition samples by calculating a representative metric for collection of points across the width of the lane using the condition samples. In one example, condition samples are divided into multiple sets using a histogram, and the average sample around the histogram point is calculated using each set of samples. In another example, a bell curve is used as a weighting factor to calculate a weighted average at multiple points across the lateral width of the lane, and these weighted averages are used to define the profile. In yet another example, splines are applied to the individual points and a curve is fit to the samples. In yet another example, curve-fitting techniques are applied to generate the profile from the collection of condition samples.

In some examples, the lane condition 742 includes a wear score 756. The wear score 756 is a scaler measure of overall road condition. In some embodiments, the wear score 756 is used to choose a particular lane on which to travel, for example on a multilane divided highway. In various examples, the wear score 756 is determined by examining the profiles above and identifying the lane position that has the lowest combined acoustic, vibration, and defect values for each selectable lane. In some examples, the system determines a maintenance score that weights defect and vibration measures into a single metric useful for determining when road maintenance or repair is necessary. For example, one embodiment compares a threshold value to vibration and defect measures to determine when road maintenance or repair is necessary. Another example integrates vibration and defect measures over the lateral width of the roadway to generate a scaler score of overall road condition.

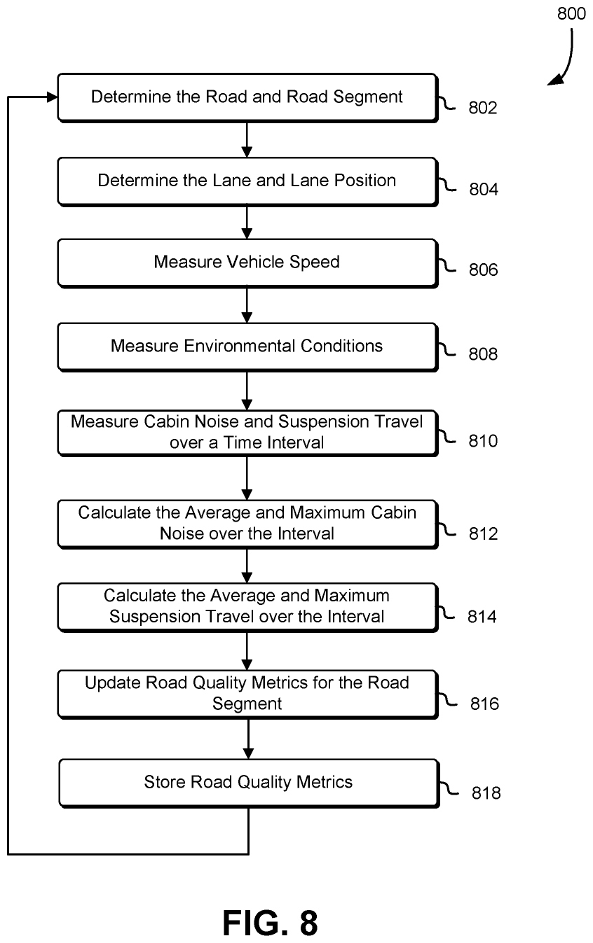

FIG. 8 illustrates an example of a process 800 that, as a result of being performed by one or more processors of a computer system, causes the computer system to collect road-condition information, in at least one embodiment. In one embodiment, the process is performed by a computer system that is part of a vehicle. In at least one example, the computer system implements a road-condition measurement computer system and a vehicle control computer system as described herein. In one example, executable instructions stored in a computer memory are executed by one or more processors that cause the system to perform the steps described below.

In one example, the process begins at step 802 where the computer system determines the road and road segment on which the vehicle is traveling. The road can be highway, roadway, street, Boulevard, or other path on which vehicles travel. The road segment me identified by mile marker, address range, or by the endpoints of the road segment on which the vehicle is traveling. In one example, the vehicle uses global positioning system signals obtained by a GPS receiver combined with a navigational database to identify the particular road and road segment on which the vehicle is traveling. In another example, the system uses cell phone signals to determine the vehicle's position and identify the roadway. In yet another example, the vehicle is equipped with a camera, and images are obtained with the camera and processed by the computer system to identify road signs, and the content of the road signs are used to identify the road and the road segment.

In at least one embodiment, at block 804, the computer system determines the lane on which the vehicle is traveling and the lateral position within the lane. In some examples, this is performed by using a camera mounted on the vehicle, and the images are processed to identify road edges, centerlines and other reference points relative to the position of the vehicle. Some implementations use radar, lidar, or ultrasonic ranging to aid in the identification of road lanes and lane position. This information is used to infer the position of the lateral position of the vehicle on the road. Some examples interact with autonomous or semiautonomous driver assist functions of the vehicle to obtain this information.

In various examples, at block 806, the computer system measures the vehicles speed of travel over the roadway and stores this information as a parameter of the road-condition sample to be acquired. At block 808, in various examples, the computer system records a variety of environmental conditions that are stored with the road-condition sample. In various examples, environmental conditions include one or more of air temperature, humidity, tire temperature, road temperature, visibility, time of day, and light level.

In at least one embodiment, at block 810, the computer system begins collecting information used to determine road condition by measuring noise level in the passenger cabin and suspension travel over a time interval. In some examples, the time interval is selected based on the speed at which the vehicle is traveling and the typical distance between expansion joints in a roadway. In one example, a time interval is chosen such that at least one expansion joint will be encountered during the interval to account for periodic roughness caused by defective joints in the road. In at least one embodiment, at block 812, the computer system calculates the average and maximum cabin noise over the time interval. In at least one embodiment, at block 814, the computer system calculates the average and maximum suspension travel over the time interval.

In at least one example, at block 816, the computer system uses the information collected above to update a set of road quality metrics for the current road segment. In one example, road quality measures are stored in a histogram representing different lateral locations within the current lane. Each data element of the histogram is an average of the road-condition samples obtained at that lane position. For example, when the car is traveling in the center of the lane, road-condition samples obtained are averaged into a previously-recorded average of previous road-condition samples also taken in the center of the lane. In at least one embodiment, at block 818, the road quality metrics are stored in a memory of the computer system. In some examples, the road quality metrics can be uploaded to a remote server where they can be aggregated and shared with other vehicles.

After processing data from one interval, execution returns to block 802 where additional data can be collected for the current or the next road segment. Over time, a vehicle may collect many samples of road wear over a variety of lateral lane positions. This allows the computer system or a remote server to aggregate this information into a profile of wear as a function of lateral lane position.

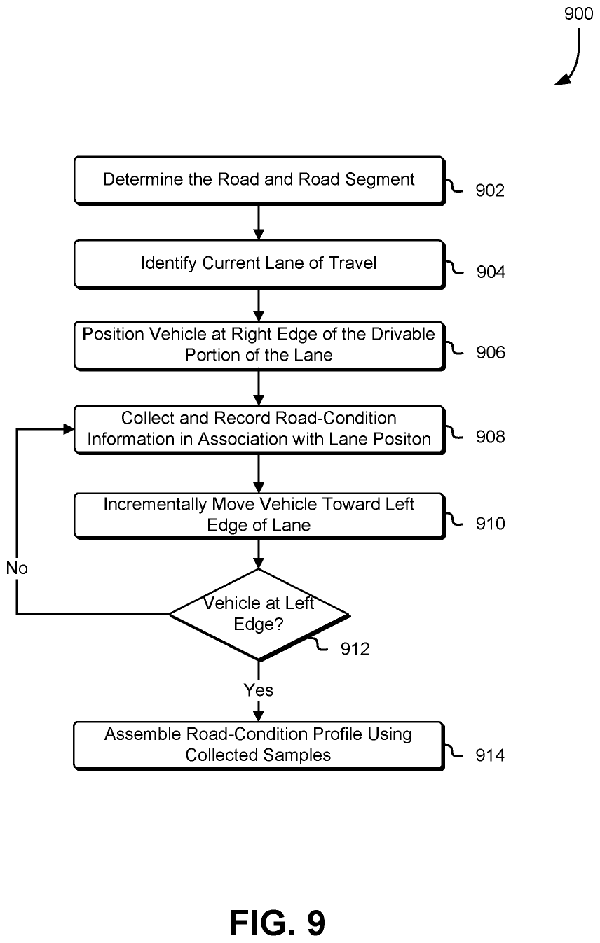

FIG. 9 illustrates an example of a process 900 that, as a result of being performed by one or more processors of a computer system, causes the computer system to calculate a road-condition profile, in at least one embodiment. In various examples, a road-condition profile is information that describes a relationship between a vehicle's lateral position within a lane of a road and road condition at that lateral position. For example, using the road-condition profile, an autonomous or semiautonomous vehicle is able to estimate the condition of a roadway at a particular lateral position of the vehicle or vehicle tire. In some examples, the autonomous or semiautonomous vehicle uses the road-condition profile to select a lateral lane position that provides improvements in road noise and ride. Various examples may create a profile based on vehicle position, whereas others may create a profile based on individual lateral positioning of the wheels of the vehicle. For a profile based on the lateral position of the wheels, overall road noise and vibration can be determined by adding the values of predicted road noise and vibration for each wheel. Different weights may be applied to different wheels based on each wheels contribution to noise or ride quality, as for example, front wheels may contribute more to road noise and ride quality than rear wheels for many vehicles. One example of how to calculate a road-condition profile is as follows.

At block 902, the computer system determines the road and road segment on which the vehicle is traveling. In one example, the computer system interfaces with a GPS receiver and a navigational database to identify a roadway on which the vehicle is traveling. In at least one example, at block 904, the computer system identifies a lane of the roadway on which the vehicle is traveling. This can be accomplished by processing images obtained from a camera mounted on the vehicle roadway markings and lane edges, and their position relative to the camera. In some examples, the computer system interfaces with an autonomous or semiautonomous driving system to obtain information about the current lane of travel and the lateral position within the lane of travel.

In at least one example, the computer system determines the profile by directing a autonomous or semiautonomous vehicle to laterally drift from one edge of the current lane to the other edge of the current lane as it is traveling down the road. At block 906, the computer system directs the autonomous vehicle to laterally position the vehicle at the right edge of the drivable portion of the current lane. At block 908, the computer system collects and records road-condition information and stores this information in association with the current lateral lane position. Road-condition information can include sound levels recorded from the cabin, and suspension vibration as described above. At block 910, the computer system directs the autonomous vehicle to move incrementally toward the left edge of the current lane as it is driving down the road. At block 912, if the vehicle is that the left edge of the current lane, execution advances the block 914. If the vehicle is not at the left edge of the current lane, execution returns to block 908 and the computer system collects and records road-condition information for the new position. This process repeats until the vehicle has across the width of the lane collecting road-condition information at multiple lateral positions. Some examples do not direct the vehicle to drift across the lane, but instead collect samples passively at whatever lateral position the vehicle is at, whether controlled by an autonomous system or a human driver.

In at least one embodiment, at block 914, the data collected during the process of drifting across the lateral width of the current lane is assembled into a profile that represents road condition as a function of lateral lane position. For example, the profile may be created by creating a table of road wear versus lane position which can be interpolated to estimate road condition at any lateral lane position for the current lane. Some examples use curve-fitting algorithms to generate a function describing relationship between lateral lane position and measured road wear.

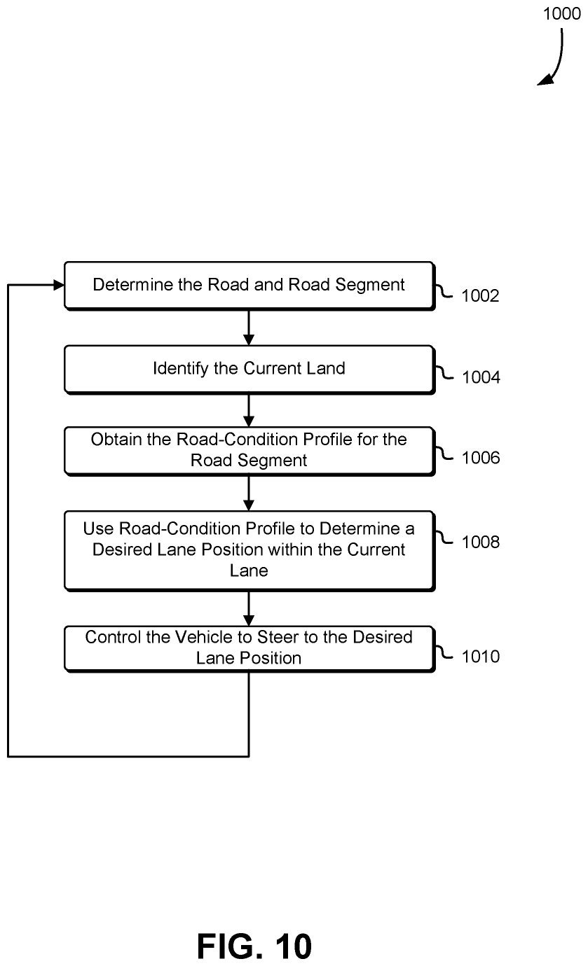

FIG. 10 illustrates an example of a process 1000 that, as a result of being performed by one or more processors of a computer system, causes the computer system to determine a desired position within a lane of a road based at least in part on road-condition information, in at least one embodiment. In one example, the process begins at step 1002 where the computer system determines the road and road segment on which the vehicle is traveling. The road can be highway, roadway, street, Boulevard, or other path on which vehicles travel. The road segment me identified by mile marker, address range, or by the endpoints of the road segment on which the vehicle is traveling. In one example, the vehicle uses global positioning system signals obtained by a GPS receiver combined with a navigational database to identify the particular road and road segment on which the vehicle is traveling. In another example, the system uses cell phone signals to determine the vehicles position and identify the roadway. In yet another example, the vehicle is equipped with a camera, and images are obtained with the camera and processed by the computer system to identify road signs, and the content of the road signs are used to identify the road and the road segment.

In at least one example, at block 1004, the computer system identifies the current lane on which the vehicle is traveling. In some examples this is accomplished by processing images obtained from a camera mounted on the front of the vehicle. Images from the camera are processed to identify roadway markings and edges and the location of these markings and edges in the images allow the computer system to infer the lateral position of the vehicle within the lane of the roadway.

In at least one example, at block 1006, the computer system obtains the road-condition profile for the current road segment, lane, and lateral position within the lane. In some examples, the road-condition profile is stored in a memory of the computer system and is generated by the vehicle as described above. In other examples, the road-condition profile is downloaded from a remote server over a wireless network.

At block 1008, the computer system uses the road-condition profile to determine a desired lane position within the current lane. In some examples, the road-condition profile describes road condition as a function of vehicle lateral position. In such examples, the computer system uses the road-condition predicted by the profile in combination with other safety concerns such as distance to oncoming traffic and distance from lane edge to calculate a desired lateral position within the lane that considers all these factors. For example, the system may select a lateral lane position within the middle ⅔rds of the lane with the best predicted ride quality. In some examples, the computer system uses the road-condition profile to identify a lateral lane position with improved ride and road noise. At block 1010, the computer system directs the vehicle to move to the desired lateral lane position, thereby achieving improved ride and reduced road noise for the passenger in many examples.

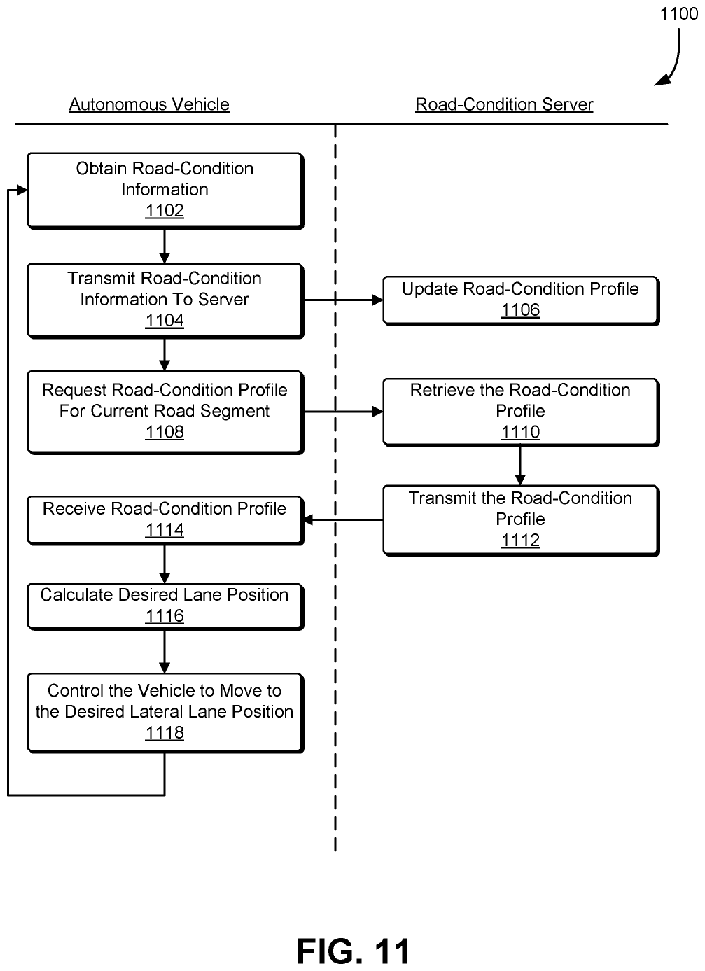

FIG. 11 illustrates an example of a process 1100 that, as a result of being performed by an autonomous vehicle and a road-condition server, collects, processes, and distributes road-condition information usable to control the autonomous vehicle, in at least one embodiment. In at least one embodiment, the autonomous vehicle includes a processor and one or more memories storing executable instructions that, as a result of being executed by the one or more processors, cause the autonomous vehicle to perform the operations described below. In at least one example, the road-condition server is a computer system containing a processor and memory storing instructions that, as a result of being executed by the one or more processors, cause the road-condition server to perform operations that maintain and distribute road-condition profiles as described below.

In one example, at block 1102, the autonomous vehicle obtains road-condition information for the current road segment and lateral lane position being traversed by the autonomous vehicle. In one example, the road-condition information includes road noise and/or suspension-movement information as described above. In one example, at 1104, the autonomous vehicle transmits the road-condition information to the road-condition server. In various examples, the autonomous vehicle includes a cellular network interface that communicates wirelessly with the road-condition server which is connected to the network. In some examples, the autonomous vehicle connects to a cellular interface such as a mobile phone using a Wi-Fi or Bluetooth interface, and information is relayed from the mobile phone to the road-condition server via the cellular network. In yet another example, road-condition information is buffered in memory on the autonomous vehicle, and when the autonomous vehicle comes within range of a wireless network such as a Wi-Fi network, road-condition information is uploaded to the road-condition server.

In one example, at block 1106, the road-condition server receives the road-condition information from the autonomous vehicle and updates one or more road-condition profiles using the received information. In one example, the road-condition profiles are created as described above. In another example, the road-condition profiles are created by adding the road-condition information to other road-condition information uploaded by other autonomous vehicles for the given road segment to create the road-condition profile. At least one example accepts road-condition information in the form of road-condition measures paired with lateral lane positions. These pairs form a set of two-dimensional points to which a curve fitting algorithm is applied to generate a function that converts lateral lane position to an estimated road condition.

At block 1108, at least one example of the autonomous vehicle requests, from the road-condition server, a road-condition profile for the current road segment on which the vehicle is traveling. In one example, the autonomous vehicle identifies the current road and road segment, and transmits this information to the road-condition server with a request that any road-condition profile matching the current road and road segment be returned to the autonomous vehicle. In at least one example, at block 1110, the road-condition server receives the request for the road-condition profile information. The road-condition server queries a database of road-condition profiles maintained on the server and retrieves the road-condition profile for the current road segment. At block 1112, the road-condition server transmits the road-condition profile to the autonomous vehicle.

In at least one embodiment, at block 1114, the autonomous vehicle receives the road-condition profile from the road-condition server. The autonomous vehicle uses the road-condition profile to determine a desired lateral lane position at block 1116. In various examples, the desired lateral lane position is calculated as described above. In one example, the desired lane position is calculated by applying a set of user preferences to the road-condition profile. User preferences may include a weight of road noise, ride smoothness, and distance from lane edges. In one example, by applying the weight to the road-condition profile, and optimal lateral-lane position can be determined in accordance with user preferences.

In at least one example, at block 1118, the autonomous vehicle is controlled to move to the desired lateral lane position. In various examples, this may be accomplished by establishing a new desired lane position for an autonomous-driving subsystem. In other examples, the desired lateral lane position is established by steering the path of the vehicle slightly towards the desired lateral lane position as the vehicle travels down the road. In some examples, a lane centering or driver assist system is modified to set the lateral lane position to the desired position. For example, in such embodiments, instead of merely centering the vehicle's position within the current lane, the driver assist system would neutrally position the vehicle at the desired lateral lane position, providing an improved ride and less road noise with minimal driver input.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denote that the instructions are being executed by a machine, thereby causing the machine to perform the specified operations.

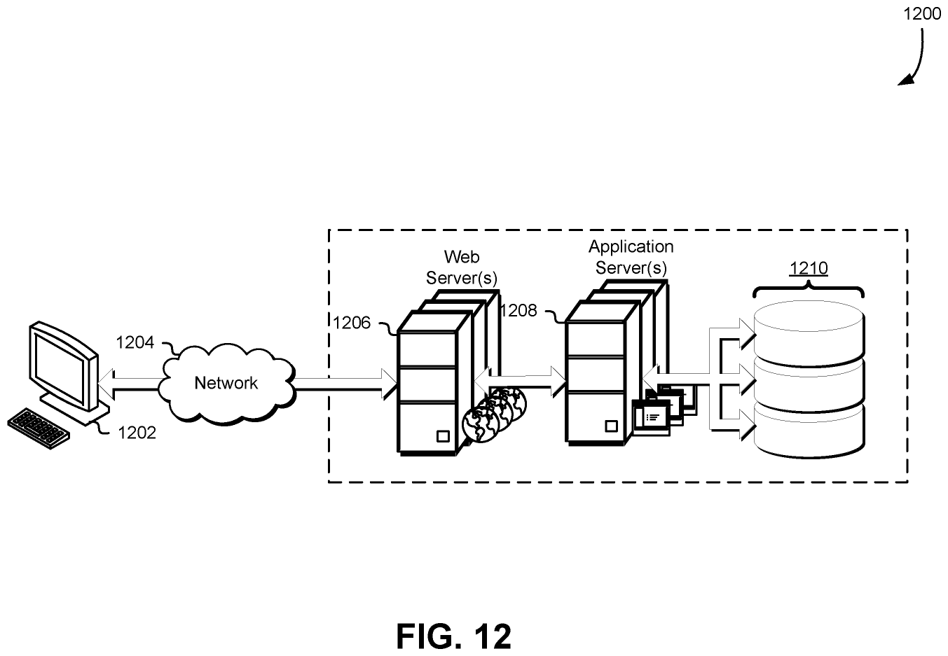

FIG. 12 illustrates aspects of an example environment 1200 for implementing aspects in accordance with various embodiments. As will be appreciated, although a web-based environment is used for purposes of explanation, different environments may be used, as appropriate, to implement various embodiments. The environment includes an electronic client device 1202, which can include any appropriate device operable to send and/or receive requests, messages, or information over an appropriate network 1204 and convey information back to a user of the device. Examples of such client devices include personal computers, cell phones, handheld messaging devices, laptop computers, tablet computers, set-top boxes, personal data assistants, embedded computer systems, electronic book readers, and the like.

The environment 1200 in one embodiment is a distributed and/or virtual computing environment utilizing several computer systems and components that are interconnected via communication links, using one or more computer networks or direct connections. However, it will be appreciated by those of ordinary skill in the art that such a system could operate equally well in a system having fewer or a greater number of components than those illustrated in FIG. 12. Thus, the depiction in FIG. 12 should be taken as being illustrative in nature and not limiting to the scope of the disclosure.

The network 1204 can include any appropriate network, including an intranet, the Internet, a cellular network, a local area network, a satellite network or any other network, and/or combination thereof. Components used for such a system can depend at least in part upon the type of network and/or environment selected. Many protocols and components for communicating via such network 1204 are well known and will not be discussed in detail. Communication over the network 1204 can be enabled by wired or wireless connections and combinations thereof. In an embodiment, the network 1204 includes the Internet and/or other publicly-addressable communications network, as the environment 1200 includes one or more web servers 1206 for receiving requests and serving content in response thereto, although for other networks an alternative device serving a similar purpose could be used as would be apparent to one of ordinary skill in the art.

The illustrative environment 1200 includes one or more application servers 1208 and data storage 1210. It should be understood that there can be several application servers, layers or other elements, processes or components, which may be chained or otherwise configured, which can interact to perform tasks such as obtaining data from an appropriate data store. Servers, as used, may be implemented in various ways, such as hardware devices or virtual computer systems. In some contexts, “servers” may refer to a programming module being executed on a computer system. As used, unless otherwise stated or clear from context, the term “data store” or “data storage” refers to any device or combination of devices capable of storing, accessing, and retrieving data, which may include any combination and number of data servers, databases, data storage devices, and data storage media, in any standard, distributed, virtual, or clustered environment.

The one or more application servers 1208 can include any appropriate hardware, software and firmware for integrating with the data storage 1210 as needed to execute aspects of one or more applications for the electronic client device 1202, handling some or all of the data access and business logic for an application. The one or more application servers 1208 may provide access control services in cooperation with the data storage 1210 and is able to generate content including, text, graphics, audio, video, and/or other content usable to be provided to the user, which may be served to the user by the one or more web servers 1206 in the form of HyperText Markup Language (HTML), Extensible Markup Language (XML), JavaScript, Cascading Style Sheets (CSS), JavaScript Object Notation (JSON), and/or another appropriate client-side structured language. Content transferred to the electronic client device 1202 may be processed by the electronic client device 1202 to provide the content in one or more forms including forms that are perceptible to the user audibly, visually, and/or through other senses. The handling of all requests and responses, as well as the delivery of content between the electronic client device 1202 and the one or more application servers 1208, can be handled by the one or more web servers 1206 using PHP: Hypertext Preprocessor (PHP), Python, Ruby, Perl, Java, HTML, XML, JSON, and/or another appropriate server-side structured language in this example. Further, operations described as being performed by a single device may, unless otherwise clear from context, be performed collectively by multiple devices, which may form a distributed and/or virtual system.

Each server typically will include an operating system that provides executable program instructions for the general administration and operation of that server and typically will include a computer-readable storage medium (e.g., a hard disk, random access memory, read only memory, etc.) storing instructions that, when executed (i.e., as a result of being executed) by a processor of the server, allow the server to perform its intended functions.

The data storage 1210 can include several separate data tables, databases, data documents, dynamic data storage schemes, and/or other data storage mechanisms and media for storing data relating to a particular aspect of the present disclosure. For example, the data storage 1210 may include mechanisms for storing various types of data and user information 1216, which can be used to serve content to the electronic client device 1202. The data storage 1210 also is shown to include a mechanism for storing log data, such as application logs, system logs, access logs, and/or various other event logs, which can be used for reporting, analysis, or other purposes. It should be understood that there can be many other aspects that may need to be stored in the data storage 1210, such as page image information and access rights information, which can be stored in any of the above listed mechanisms as appropriate or in additional mechanisms in the data storage 1210. The data storage 1210 is operable, through logic associated therewith, to receive instructions from the one or more application servers 1208 and obtain, update, or otherwise process data in response thereto. The one or more application servers 1208 may provide static, dynamic, or a combination of static and dynamic data in response to the received instructions. Dynamic data, such as data used in web logs (blogs), shopping applications, news services, and other applications may be generated by server-side structured languages as described or may be provided by a content management system (CMS) operating on, or under the control of, the one or more application servers 1208.

In one embodiment, a user, through a device operated by the user, can submit a search request for a match to a particular search term. In this embodiment, the data storage 1210 might access the user information to verify the identity of the user and obtain information about items of that type. The information then can be returned to the user, such as in a results listing on a web page that the user is able to view via a browser on the electronic client device 1202. Information related to the particular search term can be viewed in a dedicated page or window of the browser. It should be noted, however, that embodiments of the present disclosure are not necessarily limited to the context of web pages, but may be more generally applicable to processing requests in general, where the requests are not necessarily requests for content.

The various embodiments further can be implemented in a wide variety of operating environments, which in some embodiments can include one or more user computers, computing devices, or processing devices that can be used to operate any of a number of applications. User or client devices can include any of a number of computers, such as desktop, laptop, or tablet computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via the network 1204. These devices also can include virtual devices such as virtual machines, hypervisors, and other virtual devices capable of communicating via the network 1204.

Various embodiments of the present disclosure utilize the network 1204 that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), and Common Internet File System (CIFS). The network 1204 can be, for example, a local area network, a wide-area network, a virtual private network, the Internet, an intranet, an extranet, a public switched telephone network, an infrared network, a wireless network, a satellite network, and any combination thereof. In some embodiments, connection-oriented protocols may be used to communicate between network endpoints. Connection-oriented protocols (sometimes called connection-based protocols) are capable of transmitting data in an ordered stream. Connection-oriented protocols can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering.

In embodiments utilizing the one or more web servers 1206, the one or more web servers 1206 can run any of a variety of server or mid-tier applications, including Hypertext Transfer Protocol (HTTP) servers, FTP servers, Common Gateway Interface (CGI) servers, data servers, Java servers, Apache servers, and business application servers. The server(s) also may be capable of executing programs or scripts in response to requests from user devices, such as by executing one or more web applications that may be implemented as one or more scripts or programs written in any programming language, such as Java®, C, C# or C++, or any scripting language, such as Ruby, PHP, Perl, Python, or TCL, as well as combinations thereof. The server(s) may also include database servers, including those commercially available from Oracle®, Microsoft®, Sybase®, and IBM® as well as open-source servers such as MySQL, Postgres, SQLite, MongoDB, and any other server capable of storing, retrieving, and accessing structured or unstructured data. Database servers may include table-based servers, document-based servers, unstructured servers, relational servers, non-relational servers, or combinations of these and/or other database servers.

The environment 1200 can include a variety of data stores and other memory and storage media as discussed above. These can reside in a variety of locations, such as on a storage medium local to (and/or resident in) one or more of the computers or remote from any or all of the computers across the network 1204. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, a central processing unit (CPU or processor), an input device (e.g., a mouse, keyboard, controller, touch screen, or keypad), and an output device (e.g., a display device, printer, or speaker). Such a system may also include one or more storage devices, such as disk drives, optical storage devices, and solid-state storage devices such as random access memory (RAM) or read-only memory (ROM), as well as removable media devices, memory cards, flash cards, etc.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A computer-implemented method, comprising:
using one or more sensors on a vehicle to obtain road-condition information;
determining a lateral position of the vehicle within a lane of travel;
storing, in a physical memory device, the road-condition information in association with the lateral position;
determining a target lateral position within the lane of travel using the stored road-condition information; and
causing the vehicle to be moved to the target lateral position within the lane of travel.

2. The computer-implemented method of claim 1, wherein:
the lane of travel is a lane of a road;
the vehicle is an autonomous vehicle; and
the vehicle is traveling down the road when the road-condition information is obtained.

3. The computer-implemented method of claim 1, further comprising:
obtaining additional road-condition information for a plurality of lateral positions;
using the additional road-condition information to generate a profile that describes road condition as a function of lateral position; and
wherein the target lateral position is determined using the profile.

4. The computer-implemented method of claim 1, wherein:
the road-condition information is sound information; and
the one or more sensors include a microphone attached to the vehicle.

5. The computer-implemented method of claim 1, wherein:
the road-condition information includes information relating to one or more forces acting on the vehicle; and
the one or more sensors include a sensor attached to a suspension component of the vehicle.

6. The computer-implemented method of claim 5, wherein:
the suspension component is an unsprung component of the suspension; and
the information relating to the one or more forces acting on the vehicle describes the motion of the unsprung component of the suspension.

7. The computer-implemented method of claim 5, wherein:
the suspension component is a sprung component of the suspension; and
the information relating to the one or more forces acting on the vehicle describes the motion of a sprung component.

8. A system, comprising:
one or more processors;
memory that stores computer-executable instructions that, if executed, cause the one or more processors to:
obtain information that describes a relationship between a lateral position of a vehicle within a lane, and a road condition;
determine a target lateral position within the lane using the information; and
cause the vehicle to be move longitudinally along the lane at the target lateral position within the lane.

9. The system of claim 8, wherein the information is associated with information that describes a segment of a road.

10. The system of claim 8, wherein at least a portion of the information is obtained by receiving the information via a wireless computer network from a server.

11. The system of claim 10, wherein the information is received in response to a request that specifies a segment of a road.

12. The system of claim 8, wherein the computer-executable instructions, if executed by the one or more processors, further cause the system to:
obtain additional information that describes relationships between a plurality of lateral positions and respective road conditions;
use the additional information to generate a profile that describes road condition as a function of lateral position; and
determine the target lateral position using the profile.

13. The system of claim 8, wherein the computer-executable instructions, if executed by the one or more processors, further cause the system to:
transmit the information to a computer server via a wireless network;
receive, from the computer server, via the wireless network, a profile that describes road condition as a function of lateral position; and
determine the target lateral position using the profile.

14. The system of claim 8, wherein:
the vehicle is a semi-autonomous vehicle; and
the vehicle is controlled to assist a human driver in maintaining a lateral position at the target lateral position.

15. The system of claim 8, wherein the computer-executable instructions, if executed by the one or more processors, further cause the system to:
record a vehicle speed in association with the lateral position of the vehicle within the lane, and the information; and
generate a target speed based at least in part on the information.

16. The system of claim 8, wherein the computer-executable instructions, if executed by the one or more processors, further cause the system to select a target lane for travel from a plurality of lanes based at least in part on the information.

17. A non-transitory computer-readable storage medium storing thereon executable instructions that, as a result of being executed by one or more processors of a computer system, cause the computer system to at least:
obtain, via a computer network, a plurality of road-condition samples from a plurality of vehicles, each road-condition sample having an associated road segment and lateral lane position;
calculate a road-condition profile for a lane of a road segment using the plurality of road-condition samples; and
in response to a request, provide the road-condition profile.

18. The non-transitory computer-readable storage medium of claim 17, wherein the instructions further comprise instructions that, as a result of being executed by the one or more processors, cause the computer system to generate the road-condition profile by averaging a plurality of road-wear measures collected by a plurality of vehicles.

19. The non-transitory computer-readable storage medium of claim 17, wherein the road-condition profile describes road condition as a function of lateral position of each wheel of a vehicle.

20. The non-transitory computer-readable storage medium of claim 17, wherein:
the request is provided by an autonomous vehicle; and
the request identifies the road segment.
